(19) United States
(12) Patent Application Publication
(10) Pub. No.: US 2007/0143686 A1
(43) Pub. Date: Jun. 21, 2007

(54) System administration console that integrates manual and autonomic tasks

(75) Inventors: Michael John Branson, Rochester, MN (US); Gregory Richard Hintermeister, Rochester, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 11/304,133

(22) Filed: Dec. 15, 2005

(51) Int. Cl. G06F 9/00

(52) U.S. Cl. 715/733; 715/741; 715/742; 715/743

(57) ABSTRACT

A system administration console integrates both manual tasks and autonomic tasks to the view of a human system administrator. The system administration console includes an autonomic administration indication mechanism that indicates to a human system administrator when autonomic managers are in the process of performing autonomic functions. The system administrator has the option of pausing or halting any displayed autonomic managers that may be running. The system administration console further includes an autonomic administration zone restriction mechanism that allows the system administrator to define one or more zones in which activity of autonomic managers may be restricted or prevented.

### BACKGROUND OF THE INVENTION

1. Technical Field

This invention generally relates to computer systems, and more specifically relates to administration of networked computer systems.

2. Background Art

Networked computer systems typically require a system administrator to perform certain functions. For example, when a new computer system needs to be added to a network, the system administrator typically must configure the new computer system by loading software that is required, connecting the new computer system to the network, and setting up a new user account with a user name and password for each user of the new computer system. Many of the tasks performed by system administrators are manual tasks, such as cleaning up storage, adding additional storage capacity, rebooting a failed server, recycling an application, adjusting cache levels, setting up monitors and deciding what event(s) to monitor, and choosing actions to take once some defined event occurs.

Recent developments in the computer industry have succeeded in automating some of the tasks that a system administrator might normally perform manually. When a computer system takes action to heal itself of a problem that develops, it is said that this self-healing behavior is “autonomic” behavior, and that tasks that perform this type of self-healing behavior are autonomic tasks. Self-healing, self-configuring, self-optimizing, and self-protecting are all known types of autonomic tasks. Autonomic tasks are performed as a result of the computer system detecting some condition that warrants corrective action, then performing the tasks to perform the corrective action without human intervention. For example, if workload across a pool of computer systems becomes unbalanced, a workload monitor could detect the unbalanced workload condition and take steps to autonomically balance the workload. This type of workload balancing had to be done manually before the introduction of autonomic managers that could perform this task autonomically. In addition, autonomic managers may have different trigger points than manual alerts on a system administrator console. As a result, it is possible for an autonomic manager to already be fixing a problem before the system administrator is given any warning that a problem exists. This leads to a situation where the system administrator is unaware of tasks an autonomic manager may be in the process of performing.

In another example, before autonomic managers, a system administrator might determine that new logical partitions should be provided to increase capacity on the system to solve some problem or to improve on an inefficiency. Now, an autonomic manager could automatically detect capacity constraints, and autonomically provision new logical partitions to increase capacity of the system without intervention by a human system administrator. As time goes on, more and more tasks that were previously performed by a human system administrator are being automated by autonomic managers. The result is an environment where many of the system administration tasks are automated, but where manual tasks must still be performed by a human system administrator.

System administrators that are used to working manually must now adjust to a world that is partially autonomic. In other words, they need to act when human intervention is necessary, and not act when an autonomic action is being performed by an autonomic manager to correct a problem. If a system administrator attempts to handle a problem in a traditional, manual manner while an autonomic manager is attempting to handle the same problem, the actions by the system administrator may conflict with action taken by the autonomic manager. Without a system administration console that integrates both autonomic tasks and manual tasks, system administrators will not have sufficient information in a partially autonomic environment to know what the consequences of their actions might be on autonomic managers that might be running.

### DISCLOSURE OF INVENTION

According to the preferred embodiments, a system administration console integrates both manual tasks and autonomic tasks to the view of a human system administrator. The system administration console includes an autonomic administration indication mechanism that indicates to a human system administrator when autonomic managers are in the process of performing autonomic functions. The system administrator has the option of pausing or halting any displayed autonomic managers that may be running. The system administration console further includes an autonomic administration zone restriction mechanism that allows the system administrator to define one or more zones in which activity of autonomic managers may be restricted or prevented.

The console display preferably displays resources in a graphical tree format. Any autonomic tasks that are running are identified graphically, along with identifying resources in the graphical tree that are affected by the autonomic tasks. The system administrator has ultimate control because the graphically displayed autonomic tasks may be paused or halted at the system administrator's command. The result is a system administration console that provide information to a human system administrator concerning the status of any autonomic tasks that might be running so the system administrator can avoid taking manual action to correct a problem that is being addressed by an autonomic manager. The system administration console also allows the system administrator to create a zone of resources where autonomic tasks may be restricted or prevented. This is very useful to prevent autonomic managers from taking action, for example, while resources within the zone are being manually changed. In essence, the system administration console of the preferred embodiments provides information that minimizes the likelihood of autonomic managers working against manual efforts of a system administrator, and vice versa.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a flow diagram of a method in accordance with the preferred embodiments;

FIG. 3 is display window showing a graphical display for an example used to illustrate method 200 in FIG. 2;

FIG. 4 is a flow diagram of a method in accordance with the preferred embodiments for restricting access by autonomic managers to resources in a defined restricted zone;

FIG. 5 is a table showing some sample restricted zones in accordance with the preferred embodiments; and

FIG. 6 is a table showing sample criteria for allowing an autonomic manager to access a restricted zone in accordance with the preferred embodiments.

### BEST MODE FOR CARRYING OUT THE INVENTION

The preferred embodiments provide a system administration console that provides information to a human system administrator regarding the status of any autonomic tasks that are currently being performed, and that allows the system administrator to define a restricted zone of resources and to restrict access to resources in the restricted zone according to one or more criteria. By integrating information regarding manual tasks and tasks performed by autonomic managers in a single console, a system administrator now has information that allows performing manual tasks in a way that does not conflict with autonomic managers, and that allows restricting autonomic managers so the autonomic managers cannot conflict with manual actions being taken by the system administrator.

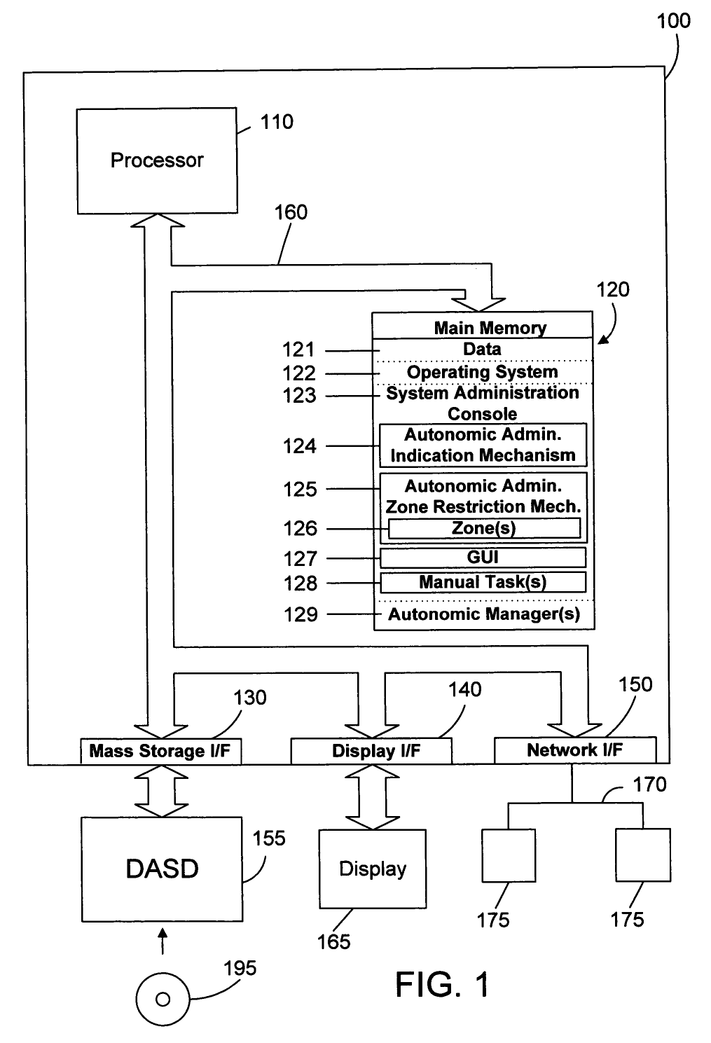

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, a system administration console 123, and one or more autonomic managers 129. Data 121 represents any data that serves as input to or output from any program in computer system 100. Operating system 122 is a multitasking operating system known in the industry as i5/OS; however, those skilled in the art will appreciate that the spirit and scope of the present invention is not limited to any one operating system. System administration console 123 provides an interface for a system administrator to perform administration functions on a computer network. The system administration console 123 includes an autonomic administration indication mechanism 124 that indicates to the system administrator when any autonomic manager 129 is performing an autonomic task. System administration console 123 further includes an autonomic administration zone restriction mechanism 125 that restricts access to one or more resources in a defined zone 126 according to specified criteria, discussed in more detail below. The system administration console 123 preferably include a graphical user interface (GUI) 127. The autonomic administration indication mechanism 124 preferably displays in the GUI 127 any autonomic tasks that are currently being performed and indicates the resources the tasks affects. The autonomic administration zone restriction mechanism 125 preferably allows a system administrator to select resources displayed in the GUI 127 for inclusion in a restricted zone. The system administration console 123 further includes one or more manual tasks 128 that may be performed by the system administrator. Autonomic manager(s) 129 include one or more software tools that autonomically perform system administration functions.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, system administration console 123, and autonomic managers 129 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links. Note that the preferred signal bearing media is tangible.

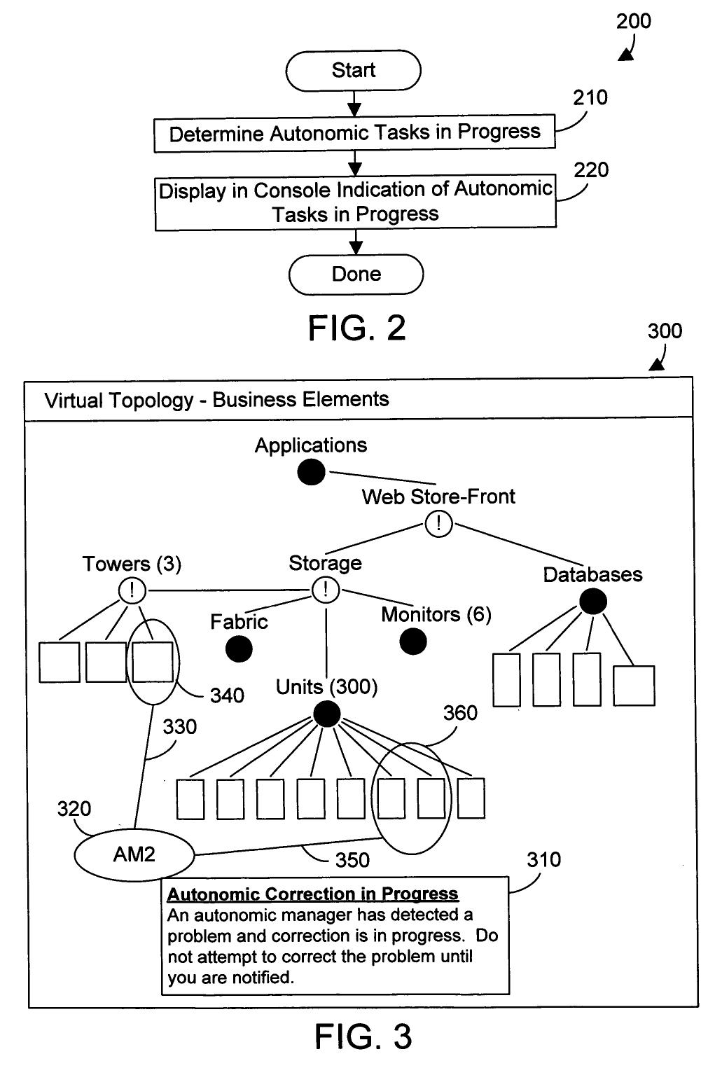

Referring to FIG. 2, a method 200 in accordance with the preferred embodiment is performed by the autonomic administration indication mechanism 124 in FIG. 1. Method 200 begins by determining what autonomic tasks, if any, are in progress (step 210). Any autonomic tasks in progress are then displayed in the console (step 220). An example of a suitable console display in accordance with the preferred embodiments is shown in display window 300 in FIG. 3. Display window 300 is a display in the graphical user interface 127 in FIG. 1. For this specific example, display window 300 includes multiple objects in a tree configuration that graphically shows relationships between objects. Note that the objects could be shown in any suitable configuration, including a tree, a graph, a directed graph, etc. The example in FIG. 3 shows an application, a web store-front, databases, storage, fabric, monitors, units, and towers. These are resources that the system administrator may decide to manage. The system administrator may decide to manage one of the displayed resources by selecting a displayed resource then invoking one of the manual tasks (e.g., 128 in FIG. 1). Note that the manual tasks may be invoked using menus in the graphical user interface, using a combination of keystrokes on a keyboard, or in any other suitable way.

Display window 300 includes an indication of an autonomic task that is in progress. This is shown by the small window 310 that informs the system administrator that an autonomic task is currently being executed. An icon 320 represents the autonomic task being performed, with the AM2 in FIG. 3 signifying that an autonomic manager identified as AM2 is currently executing the autonomic task in progress. Display window 300 also includes an indication of resources the autonomic task is currently using, as shown by line 330 and oval 340, and as shown by line 350 and oval 360. Note that oval 330 includes one tower object, while oval 36 includes two unit objects. The combination of the text window 310, icon 320, lines 330, 350, and ovals 340, 360 all make up an indication of a task currently being performed by an autonomic manager for the specific example shown in FIG. 3, and are displayed in the graphical user interface 127 by the autonomic administration indication mechanism 124 (see FIG. 1). By providing a graphical display of resources that includes an indication of a task currently being performed by an autonomic manager, the system administration console of the preferred embodiments provides information to the system administrator regarding what autonomic tasks are running so the system administrator can avoid performing manual functions that might negatively impact the autonomic tasks. In addition, by indicating which resources are being affected by the autonomic task, the system administrator knows that manual action can be taken that affect other resources while the autonomic task is running. The result is a system administration console that provides enhanced functionality in a system administration environment that includes one or more autonomic managers.

Note that a human system administrator viewing the display window 300 in FIG. 3 may take action to pause or halt any autonomic tasks that may be in progress. For example, the system administrator may have an urgent task that needs to be performed notwithstanding the fact that autonomic manager AM2 is currently acting upon one of the towers and two of the units. In this case, the system administrator could select the AM2 icon and then take action to pause or halt the autonomic task, such right-clicking on the icon and selecting “pause” or “halt” from a drop-down menu. In the alternative, the system administrator could select a function that pauses or halts all running autonomic tasks. Note that pausing or halting an autonomic task may not happen immediately because some tasks must get to a valid stopping point before they can be stopped. However, the pause or halt function in the graphical user interface allows a system administrator to pause or halt any or all autonomic tasks that are currently being performed.

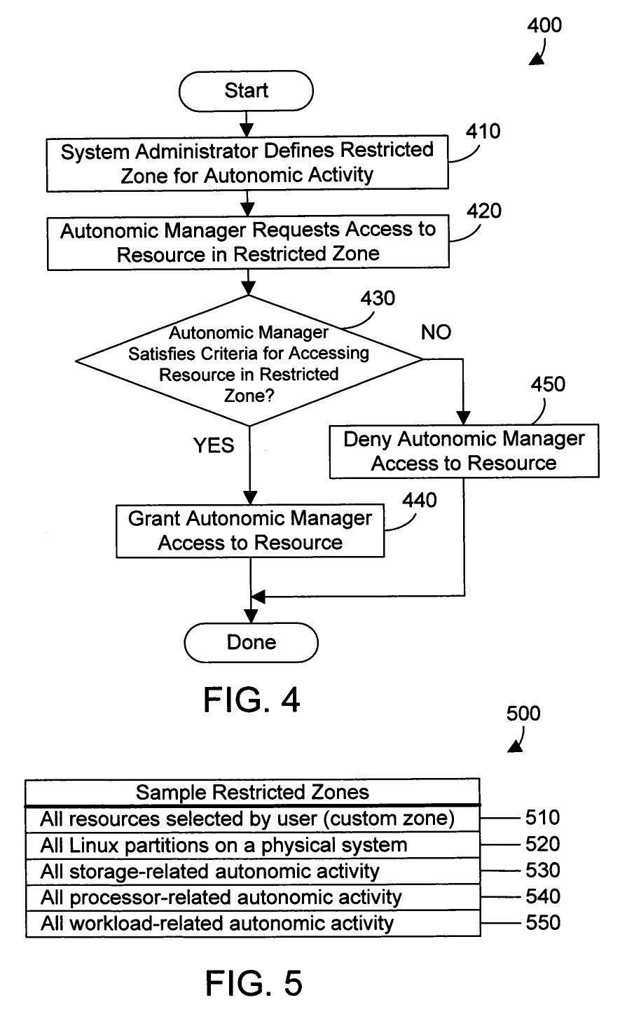

The method 200 in FIG. 2 and sample display 300 in FIG. 3 are shown as a way to prevent a human system administrator from interfering with currently-executing autonomic tasks. A need also exists to prevent an autonomic manager from interfering with something the system administrator may be trying to do manually, or to define a region where only manual administration is desired. The autonomic administration zone restriction mechanism 125 of FIG. 1 fills this need. Referring to FIG. 4, a method 400 in accordance with the preferred embodiments is performed by the autonomic administration zone restriction mechanism 125 of FIG. 1. Method 400 begins by the system administrator defining a zone that is restricted for autonomic activity (step 410). Such a zone is shown at 126 in FIG. 1. We now assume an autonomic manager requests access to a resource in a restricted zone (step 420). If the autonomic manager satisfies a specified criteria for accessing the resource in the restricted zone (step 430=YES), the autonomic manager is granted access to the resource (step 440). If the autonomic manager does not satisfy the specified criteria for accessing the resource in the restricted zone (step 430=NO), the autonomic manager is denied access to the resource (step 450). In this manner, a human system administrator can define a restricted zone that includes one or more resources, and may specify one or more criterion for determining when an autonomic manager may access a resource in the restricted zone.

Table 500 in FIG. 5 shows some sample restricted zones within the scope of the preferred embodiments. The system administrator (user) may manually select multiple resources to create a custom restricted zone that includes all of the selected resources, as shown at 510 in FIG. 5. For example, if the system administrator was getting ready to perform manual functions on the three towers shown in FIG. 3, the system administrator could select the three towers and put them in a restricted zone, and specify a criteria that AM2 is not allowed to access any of the towers in the restricted zone. This would prevent AM2 in FIG. 3 from initiating the autonomic correction shown in FIG. 3, because the correction involves a tower in a restricted zone, and AM2 is specifically designated as not being able to access the towers in the specified criteria for the restricted zone.

Table 500 shows some other sample restricted zones as well. All Linux partitions on a physical system could define a restricted zone, as shown at 520 in FIG. 5. All storage-related autonomic activity could define a restricted zone, as shown at 530. All processor-related autonomic activity could define a restricted zone, as shown at 540. And all workload-related autonomic activity could define a restricted zone, as shown at 550. Notice that 530, 540 and 550 in FIG. 5 specify a class of activity, and all resources that have the specified class of activity will be included in the restricted zone. Note that multiple restricted zones may exist at the same time. There are numerous ways to define restricted zones, and the preferred embodiments expressly extend to any suitable way to define a restricted zone.

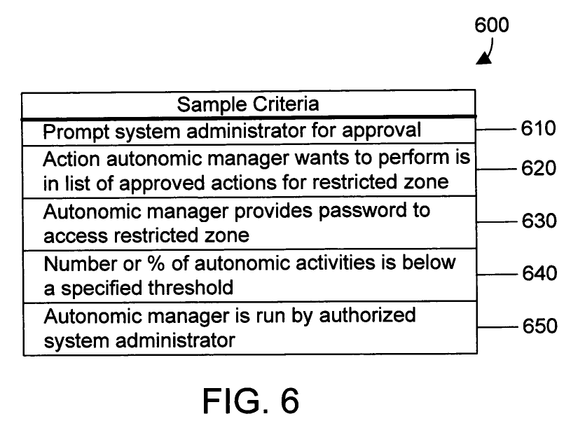

Referring to FIG. 6, table 600 shows sample criteria that could be used in step 430 in FIG. 4 for determining whether or not to grant access to an autonomic manager that requests access to a resource in a restricted zone. For example, the human system administrator may be prompted to approve the access to the resource by the autonomic manager, as shown at 610. If the system administrator approves, access is granted. If not, access is denied. The system administrator may define a list of approved actions that autonomic manager may perform on resources in a restricted zone, as shown at 620. If the action the autonomic manager wants to perform is in the list of approved actions, access is granted. If not, access is denied. The autonomic manager may be required to provide a password to access a resource in a restricted zone, as shown at 630. If the autonomic manager supplies the correct password, access is granted. If not, access is denied. Autonomic managers may also be restricted based on the number or percentage of autonomic activities, as shown at 640. If the number or percentage of autonomic activities is below a specified threshold (say, 5%), the autonomic manager is granted access to resources in the restricted zone. If not, access is denied. In addition, autonomic managers may be restricted based on which system administrator runs the autonomic manager, as shown at 650. If the autonomic manager is being run by a system administrator that is authorized to run the autonomic manager, access is granted to the resources in the restricted zone. If not, access is denied.

The sample criteria shown in table 600 in FIG. 6 are shown to illustrate just a few of the possible criteria. One skilled in the art will appreciate that many more criteria could be defined for determining whether or not an autonomic manager is allowed to access a resource in a restricted zone. The preferred embodiments expressly extend to any and all criteria that may be used for determining whether or not an autonomic manager is allowed to access a resource in a restricted zone.

The preferred embodiments provide a system administration console that integrates both manual and autonomic functions. Activity of autonomic tasks that are currently being performed is shown in a display in a graphical user interface. This allows the system administrator to evaluate what is being done autonomically before performing any manual functions. The system administrator also has the ability from the graphical user interface to pause or halt autonomic tasks that are currently being performed. In addition, a user may specify a restricted zone that includes one or more resources, along with one or more criterion for accessing a resource in the restricted zone. This prevents autonomic managers from performing tasks on the resources in the restricted zone unless the specified criteria are satisfied.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An apparatus comprising:
at least one processor;
a memory coupled to the at least one processor;
a system administration console residing in the memory and executed by the at least one processor, the system administration console comprising:
a graphical user interface that allows a human system administrator to perform a plurality of manual tasks; and
an indication mechanism that displays in the graphical user interface any task currently being performed by at least one autonomic manager.

2. The apparatus of claim 1 wherein the indication mechanism further displays in the graphical user interface which resources are affected by the task currently being performed by the at least one autonomic manager.

3. The apparatus of claim 1 wherein the system administration console further comprises a zone restriction mechanism that allows the human system administrator to define a restricted zone that includes at least one resource, wherein access to any resource in the restricted zone by an autonomic manager is granted only if specified criteria are satisfied.

4. The apparatus of claim 3 wherein the human system administrator selects the at least one resource in the restricted zone.

5. The apparatus of claim 3 wherein the at least one resource in the restricted zone is selected by specifying a class of activity and including in the restricted zone at least one resource that has the specified class of activity.

6. The apparatus of claim 3 wherein the specified criteria is selected from the group comprising:
a prompt to the human system administrator for approval;
a list of approved actions for the restricted zone;
requiring password authorization of the autonomic manager;
allowing the autonomic manager access only if a number or percentage of autonomic activities is below a specified threshold; and
the autonomic manager is run by an authorized system administrator.

7. The apparatus of claim 1 wherein the graphical user interface includes a mechanism to pause or cancel at least one task currently being performed by at least one autonomic manager.

8. A computer-implemented method for providing a system administration console, the method comprising the steps of:
providing a graphical user interface that allows a human system administrator to perform a plurality of manual tasks; and
displaying in the graphical user interface any task currently being performed by at least one autonomic manager.

9. The method of claim 8 further comprising the step of displaying in the graphical user interface which resources are affected by the task currently being performed by the at least one autonomic manager.

10. The method of claim 8 further comprising the step of providing a zone restriction mechanism in the graphical user interface that allows the human system administrator to define a restricted zone that includes at least one resource, wherein access to any resource in the restricted zone by an autonomic manager is granted only if specified criteria are satisfied.

11. The method of claim 10 further comprising the step of the human system administrator selecting the at least one resource in the restricted zone.

12. The method of claim 10 further comprising the step of selecting the at least one resource in the restricted zone by specifying a class of activity and including in the restricted zone at least one resource that has the specified class of activity.

13. The method of claim 8 wherein the graphical user interface includes a mechanism to pause or cancel at least one task currently being performed by at least one autonomic manager.

14. The method of claim 10 wherein the specified criteria is selected from the group comprising:
a prompt to the human system administrator for approval;
a list of approved actions for the restricted zone;
requiring password authorization of the autonomic manager;
allowing the autonomic manager access only if a number or percentage of autonomic activities is below a specified threshold; and
the autonomic manager is run by an authorized system administrator.

15. A computer-readable program product comprising:
a system administration console comprising:
a graphical user interface that allows a human system administrator to perform a plurality of manual tasks; and
an indication mechanism that displays in the graphical user interface any task currently being performed by at least one autonomic manager; and
computer-readable signal bearing media bearing the system administration console.

16. The program product of claim 15 wherein the computer-readable signal bearing media comprises recordable media.

17. The program product of claim 15 wherein the computer-readable signal bearing media comprises transmission media.

18. The program product of claim 15 wherein the indication mechanism further displays in the graphical user interface which resources are affected by the task currently being performed by the at least one autonomic manager.

19. The program product of claim 15 wherein the system administration console further comprises a zone restriction mechanism that allows the human system administrator to define a restricted zone that includes at least one resource, wherein access to any resource in the restricted zone by an autonomic manager is granted only if specified criteria are satisfied.

20. The program product of claim 19 wherein the human system administrator selects the at least one resource in the restricted zone.

21. The program product of claim 19 wherein the at least one resource in the restricted zone is selected by specifying a class of activity and including in the restricted zone at least one resource that has the specified class of activity.

22. The program product of claim 19 wherein the specified criteria is selected from the group comprising:
a prompt to the human system administrator for approval;
a list of approved actions for the restricted zone;
requiring password authorization of the autonomic manager;
allowing the autonomic manager access only if a number or percentage of autonomic activities is below a specified threshold; and
the autonomic manager is run by an authorized system administrator.

23. The program product of claim 15 wherein the graphical user interface includes a mechanism to pause or cancel at least one task currently being performed by at least one autonomic manager.
